(19) United States
(12) Patent Application Publication
(10) Pub. No.: US 2025/0328409 A1
(43) Pub. Date: Oct. 23, 2025

(54) COMPUTER-READABLE RECORDING MEDIUM STORING FAILURE ASSISTANCE PROGRAM, FAILURE ASSISTANCE METHOD, AND FAILURE ASSISTANCE SYSTEM

(71) Applicant: Fujitsu Limited, Kawasaki-shi (JP)

(72) Inventors: Kenji NUMAKURA, Kawasaki (JP); Koki ARIGA, Nagakute (JP); KENICHIROU SHIMOGAWA, Numazu (JP)

(73) Assignee: Fujitsu Limited, Kawasaki-shi (JP)

(21) Appl. No.: 19/060,197

(22) Filed: Feb. 21, 2025

(30) Foreign Application Priority Data
Apr. 23, 2024 (JP) 2024-069839

(51) Int. Cl. G06F 11/07; G06F 11/30

(52) U.S. Cl. CPC G06F 11/079; G06F 11/0769; G06F 11/3072

(57) ABSTRACT

A recording medium stores a program that performs failure assistance when a failure occurs in a system in which a first device controls a third device via a second device and causes a computer to execute processing including: classifying a communication pattern to identify communication, by using first information including each communication message from the first device to the second device; generating relevance degree information indicating a relevance degree between first communication between the first and second devices and second communication between the second and third devices, by using second information including a communication log between the first, second and third devices; specifying a first communication pattern that corresponds to a communication message when a failure occurs, when a failure occurs in the second device; and estimating the third device that is a communication destination to be controlled by the first device that is a communication source.

### CROSS-REFERENCE TO RELATED APPLICATION

This application is based upon and claims the benefit of priority of the prior Japanese Patent Application No. 2024-069839, filed on Apr. 23, 2024, the entire contents of which are incorporated herein by reference.

### FIELD

The embodiment discussed herein is related to a failure assistance program or the like.

### BACKGROUND

Typically, a technology is disclosed for outputting information regarding a communication error generated in communication performed between a first device and a second device or communication performed between the second device and a third device, in an information processing system in which the first device controls the third device via the second device. In such a technology, a control unit of the second device acquires a communication log in which a communication message exchanged between the second device and the third device is recorded, in response to a control message transmitted from the first device to the second device, reads control message correspondence information that stores identification information of the control message exchanged between the second device and the third device, in association with identification information of the control message transmitted from the first device to the second device, and specifies a non-transmitted control message that has not been transmitted, based on the read control message correspondence information and the acquired communication log.

Japanese Laid-open Patent Publication No. 2008-181299 and Japanese Laid-open Patent Publication No. 2019-121883 are disclosed as related art.

### SUMMARY

According to an aspect of the embodiments, a non-transitory computer-readable recording medium stores a failure assistance program that performs failure assistance when a failure occurs in a control processing system in which a first device controls a third device via a second device by using a communication message and causes a computer to execute processing including: classifying a communication pattern used to identify communication, by using first information in which each of a plurality of communication messages transmitted from the first device to the second device is recorded; generating relevance degree information that indicates a relevance degree between first communication performed between the first device and the second device and second communication performed between the second device and the third device, by using second information in which a communication log between the first device, the second device, and the third device is recorded, for each classified communication pattern; specifying a first communication pattern that corresponds to a communication message when a failure occurs, from among the plurality of classified communication patterns, when a failure occurs in the second device; and estimating the third device that is a communication destination to be controlled by the first device that is a communication source, with reference to the relevance degree information that corresponds to the specified first communication pattern.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of a failure assistance system according to an embodiment;

FIG. 2 is a diagram illustrating an example of a functional configuration of a failure assistance device according to the embodiment;

FIG. 3 is a diagram illustrating an example of a communication log file according to the embodiment;

FIG. 4 is a diagram illustrating an example of an application log file according to the embodiment;

FIG. 5 is a diagram illustrating an example of a pattern table according to the embodiment;

FIG. 6 is a diagram illustrating an example of relevance degree table generation processing according to the embodiment;

FIG. 7A is a diagram (1) illustrating an example of a relevance degree table according to the embodiment;

FIG. 7B is a diagram (2) illustrating an example of the relevance degree table according to the embodiment;

FIG. 7C is a diagram (3) illustrating an example of the relevance degree table according to the embodiment;

FIG. 8 is a diagram illustrating a relevance degree between communications;

FIG. 9 is a diagram for explaining communication destination estimation at the time of failure occurrence;

FIG. 10 is a diagram illustrating an example of a flowchart of pattern table generation processing according to the embodiment;

FIG. 11 is a diagram illustrating an example of a flowchart of the relevance degree table generation processing according to the embodiment;

FIG. 12 is a diagram illustrating an example of a flowchart of estimation processing according to the embodiment;

FIG. 13 is a diagram illustrating an example of a computer that executes a failure assistance program;

FIG. 14 is a diagram illustrating a reference example of the failure assistance system;

FIG. 15 is a reference diagram illustrating a flow of communication of a Web system;

FIG. 16 is a diagram illustrating a reference example of a procedure for generating the relevance degree table;

FIG. 17 is a diagram illustrating a reference example of the relevance degree table;

FIG. 18 is a reference diagram illustrating the relevance degree between the communications;

FIG. 19 is a diagram for explaining the communication destination estimation at the time of failure occurrence; and

FIG. 20 is a diagram for explaining a problem of the failure assistance system in the reference example.

### DESCRIPTION OF EMBODIMENTS

However, in the related art, a second device and a third device that is a communication destination for communicating with the second device have a one-to-one relationship. Therefore, the related art has a problem in that, in a case where the second device and the third device have a one-to-many relationship, it is not possible to specify a message that has not been transmitted by the second device.

In one aspect, an object of the embodiment is to accurately narrow a communication destination with which a device that is a failure occurrence source tries to communicate, even in a case where there is a plurality of communication destinations.

Hereinafter, an embodiment of a failure assistance program, a failure assistance method, and a failure assistance system disclosed in the present application will be described in detail with reference to the drawings. Note that the present invention is not limit to the embodiment.

### Reference Example of Failure Assistance System

First, a reference example of a failure assistance system 9A that performs failure assistance when a failure occurs in a control processing system in which a first device controls a third device via a second device using a communication message, will be described. Note that, as an example of the control processing system, a Web system is exemplified as an example. However, the control processing system is not limited to this.

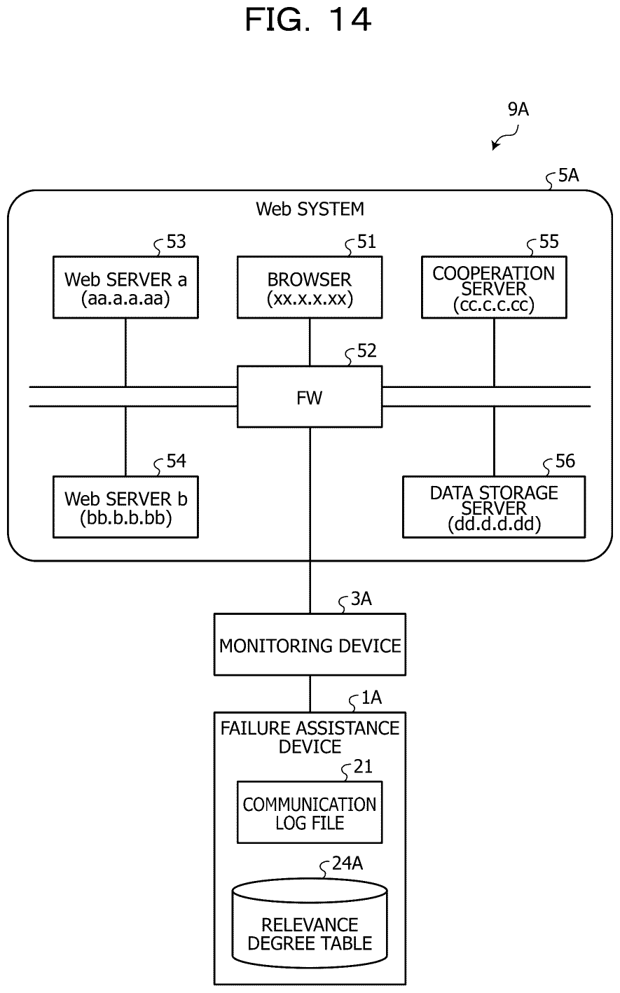

FIG. 14 is a diagram illustrating the reference example of the failure assistance system. As illustrated in FIG. 14, the failure assistance system 9A includes a Web system 5A, a failure assistance device 1A, and a monitoring device 3A.

The Web system 5A is a system on which the failure assistance is performed by the failure assistance system 9A. The Web system 5A includes a browser 51, a firewall (FW) 52, a Web server a (53), a Web server b (54), a cooperation server 55, and a data storage server 56. A number in parentheses is an internet protocol (IP) address. Note that the browser 51 is an example of the first device. The Web server a (53) and the Web server b (54) are examples of the second device. The cooperation server 55 and the data storage server 56 are examples of the third device.

The browser 51 controls the third device (for example, cooperation server 55 or data storage server 56) via the second device (for example, Web server a (53) or Web server b (54)) using the communication message.

The FW 52 allows all the communication messages in the Web system 5A to pass therethrough. The FW 52 records a communication log, when the communication message passes therethrough. Each communication log is a log of first communication performed between the first device and the second device or a log of second communication performed between the second device and the third device. In each communication log, for example, a time when communication occurs, an IP address of a transmission source, an IP address of a destination, and the like are included.

The Web server a (53) and the Web server b (54) receive the communication message from the browser 51, generate a new communication message based on the received communication message, and transmit the generated communication message to a server of a communication destination. When receiving the communication message, the Web server a (53) and the Web server b (54) record an application log. In the application log, a time when communication occurs, an HTTP method, a uniform resource identifier (URI), and a response code are included. However, in the application log, a communication destination to which a new communication message is transmitted is not recorded. Therefore, although the Web server a (53) and the Web server b (54) communicate with each of the plurality of servers, which server is set as a transmission destination cannot be determined from the application log.

The cooperation server 55 and the data storage server 56 are servers controlled by the browser 51. Note that, although the servers controlled by the browser 51 are set as the cooperation server 55 and the data storage server 56, the cooperation server 55 and the data storage server 56 are merely examples, and the servers are not limited to these functions and names.

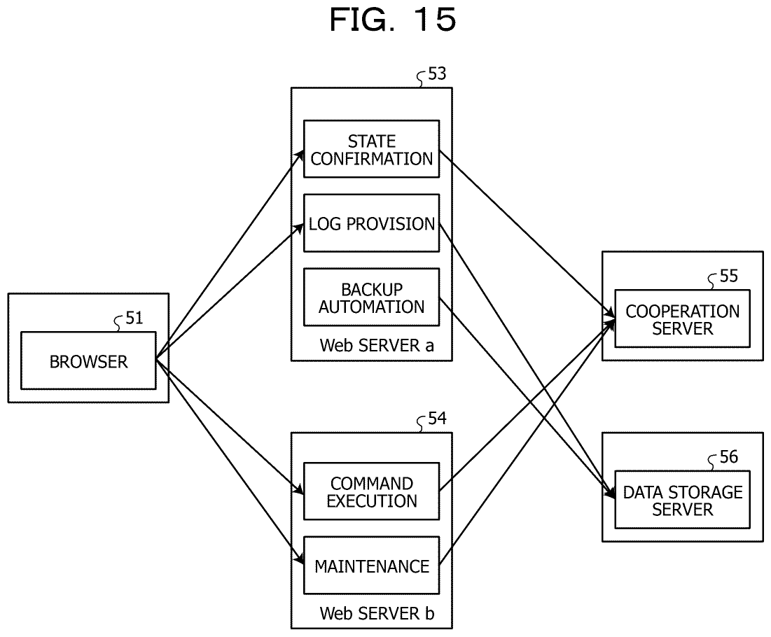

Here, an example of a flow of communication of the Web system 5A will be described with reference to FIG. 15. FIG. 15 is a reference diagram illustrating a flow of the communication of the Web system. As illustrated in FIG. 15, in the Web server a (53), for example, a state confirmation function, a log provision function, and a backup automation function are included. In the Web server b (54), for example, a command execution function and a maintenance function are included. The browser 51 confirms a state of the cooperation server 55 via the state confirmation function of the Web server a (53) using the communication message. Furthermore, the browser 51 acquires a log stored in the data storage server 56 via the log provision function of the Web server a (53) using the communication message. Furthermore, the Web server a (53) automatically executes backup of the data storage server 56 via the backup automation function, using the communication message, for example, at a predetermined time or a regular time. Furthermore, the browser 51 executes a command on the cooperation server 55, via the command execution function of the Web server b (54) using the communication message and rarely executes a command for uploading a request body to the data storage server 56. Furthermore, the browser 51 performs backup and stores logs of the cooperation server 55 via the maintenance function of the Web server b (54) using the communication message.

Returning to FIG. 14, the monitoring device 3A monitors whether or not the Web system 5A is normally operating. Therefore, the monitoring device 3A collects and accumulates the communication log of the FW 52, for example, periodically. Furthermore, when detecting occurrence of a failure, the monitoring device 3A transmits a communication log at the time of failure occurrence to the failure assistance device 1A.

The failure assistance device 1A performs failure assistance of the Web system 5A. The failure assistance device 1A includes a communication log file 21 and a relevance degree table 24A. The communication log file 21 is a file that stores communication logs in a certain period, among the communication logs accumulated in the monitoring device 3A. The failure assistance device 1A acquires the communication logs in a certain period from the monitoring device 3A and stores the communication logs in the communication log file 21. The relevance degree table 24A is information that stores a relevance degree between server communications. For example, the relevance degree table 24A is relevance degree information indicating a relevance degree between the first communication performed between the first device (browser 51) and the second device (Web server a (53) or Web server b (54)) and the second communication performed between the second device (Web server a (53) or Web server b (54)) and the third device (cooperation server 55 or data storage server 56). As the relevance degree, for example, the number of times of communications is exemplified.

The failure assistance device 1A generates the relevance degree table 24A indicating the relevance degree between the first communication and the second communication, from the communication log stored in the communication log file 21. For example, the failure assistance device 1A divides the communication log of the communication log file 21 at t-second intervals. The t seconds may be, for example, one second or two seconds, and it is sufficient that the t seconds be the number of seconds estimated to be communicated in association. The failure assistance device 1A selects one division unit. The failure assistance device 1A counts, as the relevance degree, the number of times of communication between communications including the first communication and the second communication that occur at times close to each other, from a time when each communication log included in the selected division unit occurs, a transmission source IP address and a destination IP address. The failure assistance device 1A calculates a relevance degree, for an unselected division unit. Then, the failure assistance device 1A stores the relevance degree information in the relevance degree table 24A.

### Reference Example of Procedure for Generating Relevance Degree Table

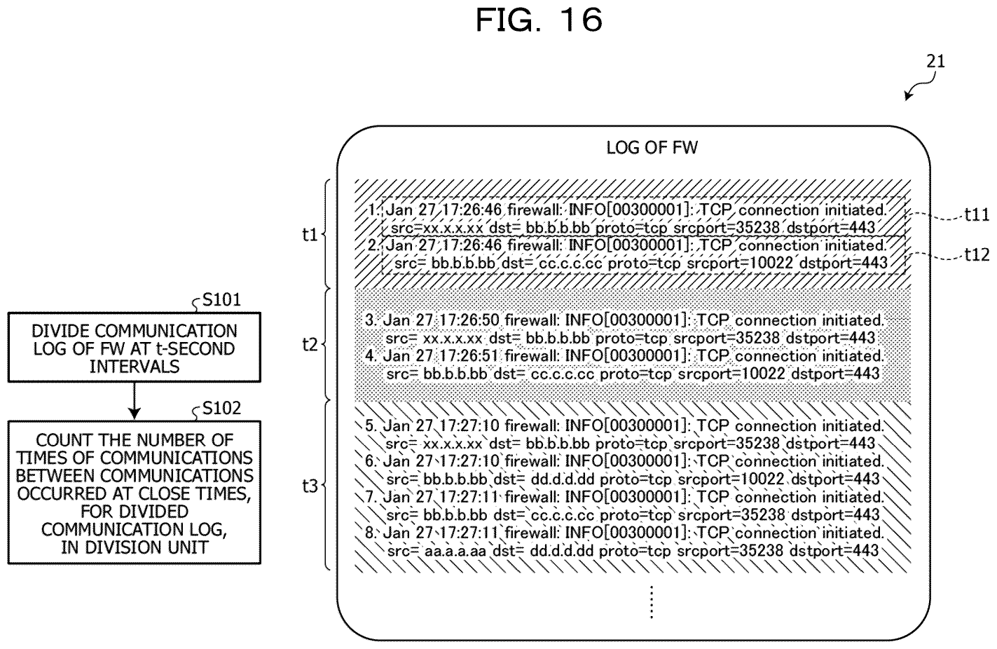

Here, a procedure for generating the relevance degree table 24A by the failure assistance device 1A will be described with reference to FIG. 16. FIG. 16 is a diagram illustrating a reference example of the procedure for generating the relevance degree table. Note that, in a right diagram in FIG. 16, the communication log file 21 is illustrated. In a left diagram in FIG. 16, a reference example of a flowchart for generating the relevance degree table 24A is illustrated.

As illustrated in the right diagram in FIG. 16, the failure assistance device 1A divides the plurality of communication logs stored in the communication log file 21 at t-second intervals (S101). Here, t seconds is set to one second. Then, the plurality of communication logs is divided into t1, t2, and t3.

Then, the failure assistance device 1A counts the number of times of communications between communications occurred at close times, as the relevance degree, for the divided communication log, in the division unit (S102). Here, in the division unit of t1, as indicated by a reference t11, there is communication from the browser 51 having “xx.x.x.xx” as the transmission source IP address to the Web server b (54) having “bb.b.b.bb” as the destination IP address. At the time close to this communication, there is communication from the Web server b (54) having “bb.b.b.bb” as the transmission source IP address to the cooperation server 55 having “cc.c.c.cc” as the destination IP address. When the communication of the browser 51→the Web server b (54) occurs, the communication of the Web server b (54)→the cooperation server 55 occurs, and the failure assistance device 1A estimates that the relevance degree is high. Then, the failure assistance device 1A adds one to the number of times of communications at the location between these communications of the relevance degree table 24A.

For communications between these communications, an opposite relationship also holds. For example, when the communication of the Web server b (54)→the cooperation server 55 occurs, the communication of the browser 51→the Web server b (54) occurs, and the failure assistance device 1A estimates that the relevance degree is high. Then, the failure assistance device 1A adds one to the number of times of communications at the location between these communications of the relevance degree table 24A.

Then, as in a case of the division unit of t1, the failure assistance device 1A counts the number of times of communications between the communications, in all the division units and generates the relevance degree table 24A.

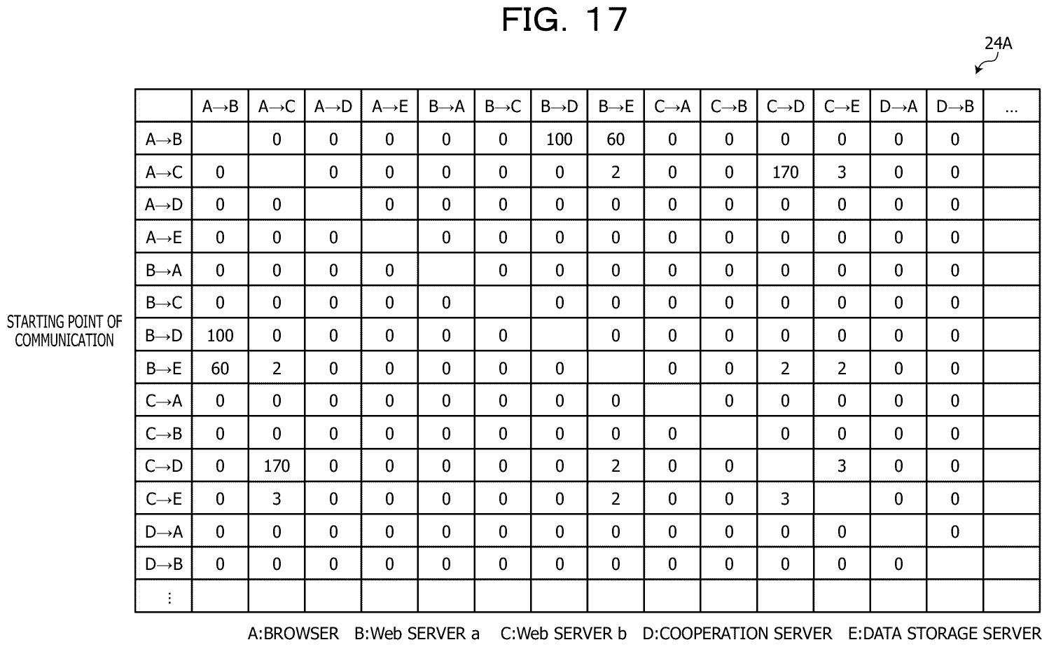

FIG. 17 is a diagram illustrating a reference example of the relevance degree table. Note that the relevance degree table 24A illustrated in FIG. 17 is generated from the communication log file 21 illustrated in the right diagram in FIG. 16.

As illustrated in FIG. 17, in the relevance degree table 24A, the vertical axis illustrates communication to be a starting point, and a horizontal axis illustrates communication that continuously occurs when the communication to be the starting point occurs. At a portion where the communication indicated by the vertical axis and the communication indicated by the horizontal axis intersect, a relevance degree between the communications, for example, the number of times when the communication occurs (the number of times of communications) is indicated. Note that “A” indicates the browser 51. “B” and “C” respectively indicate the Web server a (53) and the Web server b (54). “D” and “E” respectively indicate the cooperation server 55 and the data storage server 56.

Here, for example, in a case where A (browser 51)→C (Web server b (54)) is set as the starting point of the communication, 170 times of communication of C (Web server b (54))→D (cooperation server 55) exist at a time close to the communication of A→C. In the opposite relationship, in a case where C→D is set as the starting point of the communication, 170 times of the communication of A→C exist at the time close to the communication of C→D.

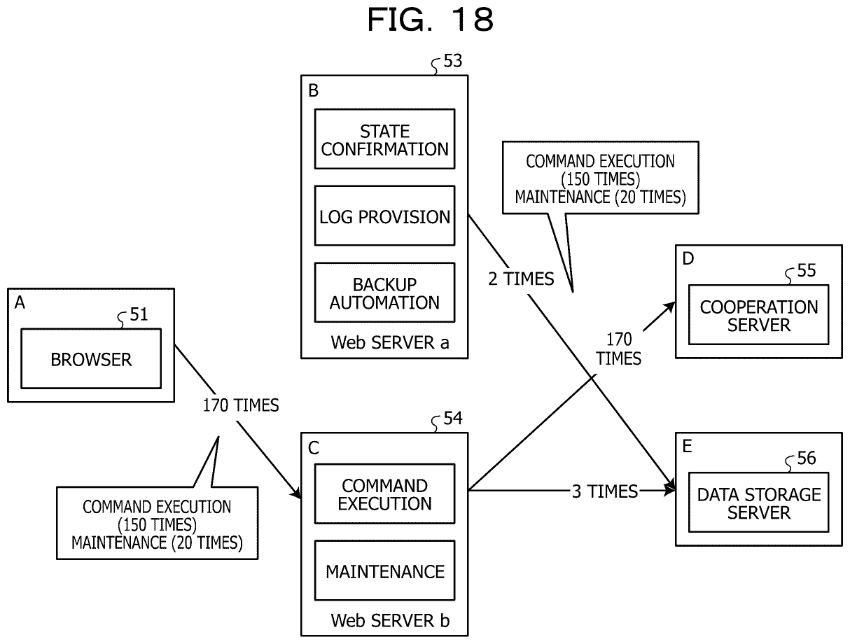

The relevance degree between the communications known from the relevance degree table 24A illustrated in FIG. 17 will be described with reference to FIG. 18. FIG. 18 is a reference diagram illustrating the relevance degree between the communications. As illustrated in FIG. 18, in a case where A (browser 51)→C (Web server b (54)) is set as the starting point of the communication, 170 times of communication of C (Web server b (54))→D (cooperation server 55) exist at a time close to the communication of A→C. A breakdown of 170 times includes 150 times of the command execution function and 20 times of the maintenance function.

Furthermore, two times of communication of B (Web server a (53))→E (data storage server 56) exist, at the time close to the communication of A→C. This is because B (Web server a (53)) executes the backup automation function twice at the close times, when C (Web server b (54)) executes the command execution function and the maintenance function. Communication of B (Web server a (53))→E (data storage server 56) is communication not related to the communication in a case where A→C is set as the starting point of the communication. Furthermore, three times of communication of C (Web server b (54))→E (data storage server 56) exist, at the time close to the communication of A→C.

Returning to FIG. 14, when detecting that a failure occurs in the Web server a (53) or the Web server b (54), the failure assistance device 1A acquires a communication log immediately before the occurrence of the failure, from the monitoring device 3A. In the communication log immediately before the occurrence of the failure, information regarding the communication to be the starting point is included. Therefore, the failure assistance device 1A refers to the relevance degree table 24A and acquires a relevance degree between communications corresponding to the communication to be the starting point at the time of occurrence of the failure. Then, the failure assistance device 1A estimates a communication destination of the communication corresponding to the communication to be the starting point, of which a relevance degree indicates a value equal to or more than a threshold, as a communication destination server.

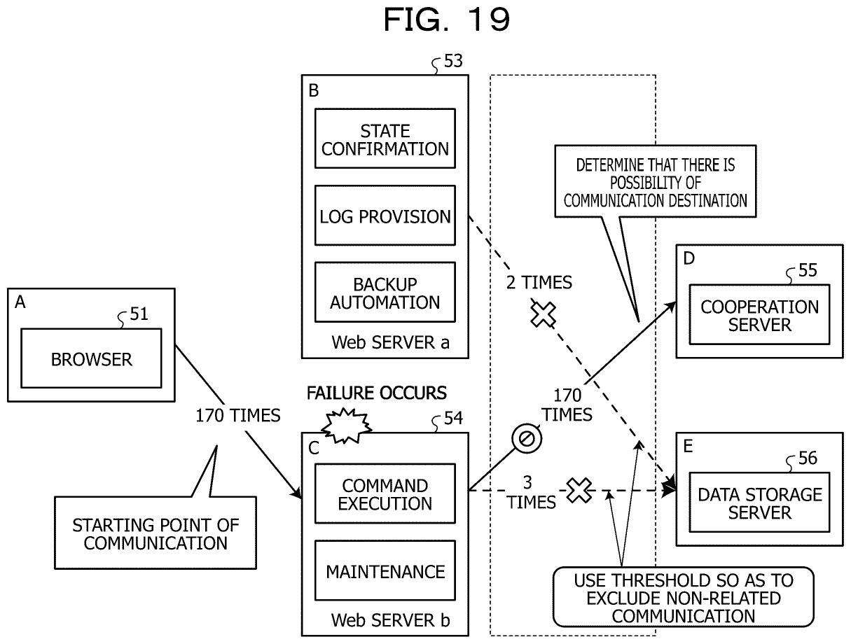

Here, processing for estimating the communication destination at the time when the failure occurs in the Web server b (54) will be described with reference to FIG. 19. FIG. 19 is a reference diagram for explaining communication destination estimation at the time of failure occurrence. Note that, in FIG. 19, a case where the relevance degree between the communications illustrated in FIG. 18 is used will be described.

When detecting that a failure occurs in the Web server b (54), the failure assistance device 1A acquires a communication log immediately before a time when the failure occurs from the monitoring device 3A. Since information regarding the communication of A (browser 51)→C (Web server b (54)) indicating the communication to be the starting point is included in the acquired communication log, the failure assistance device 1A detects that the communication of A→C occurs.

The failure assistance device 1A refers to the relevance degree table 24A and acquires the relevance degree between the communications corresponding to the communication to be the starting point at the time of occurrence of the failure. In FIG. 19, the relevance degree between the communications using A→C as the starting point is illustrated. Then, the failure assistance device 1A estimates the communication destination of the communication corresponding to the communication to be the starting point, of which the relevance degree indicates the value equal to or more than the threshold, as the communication destination server. Here, it is assumed, for example, that the threshold be 10. Then, a relevance degree between the communication of A→C and the communication of B (Web server a (53))→E (data storage server 56) is twice and a relevance degree between the communication of A→C and the communication of C (Web server b (54))→E (data storage server 56) is three times, the failure assistance device 1A excludes these communications. For example, the failure assistance device 1A excludes communication with a less communication frequency, using the threshold, so as to exclude communication that is not related to and independent from the communication using A→C as the starting point or communication with a lower relevance degree, as the backup automation function or the like. Then, the failure assistance device 1A estimates D (cooperation server 55) of the communication of C (Web server b (54))→D (cooperation server 55) of which the relevance degree is 170 times, as the communication destination.

However, there is a case where the command execution function of the Web server b (54) executes rare communication, by receiving the communication message from the browser 51. In such a case, if the failure assistance device 1A excludes the communication with a less communication frequency, using the threshold, there is a problem in that the failure assistance device 1A overlooks a necessary communication path. For example, the failure assistance device 1A may overlook meaningful communication, even if the number of times of communications is small.

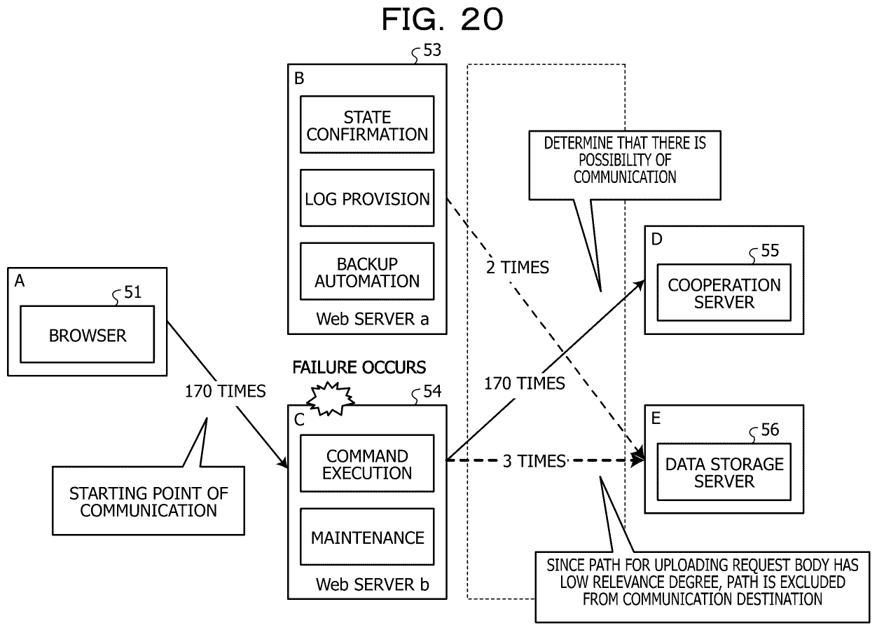

FIG. 20 is a diagram for explaining a problem of the failure assistance system in the reference example. As illustrated in FIG. 20, the failure assistance device 1A estimates the communication destination of the communication corresponding to the communication to be the starting point, of which the relevance degree indicates the value equal to or more than the threshold, as the communication destination server. Here, it is assumed, for example, that the threshold be 10. Then, the relevance degree between the communication of A→C and the communication of B (Web server a (53))→E (data storage server 56) is twice and the relevance degree between the communication of A→C and the communication of C (Web server b (54))→E (data storage server 56) is three times, the failure assistance device 1A excludes these communications. However, there is a case where the command execution function of the Web server b (54) receives the communication message from the browser 51 and rarely executes a command for uploading a request body to the data storage server 56. However, since the relevance degree between the communication of A→C and the communication of C (Web server b (54))→E (data storage server 56) is three times, the relevance degree is less than the threshold, and a communication path of C→E is excluded from the communication destination. For example, the failure assistance device 1A overlooks a communication destination with which a device (browser 51) which is a failure occurrence source tries to communicate.

Therefore, in the embodiment, a failure assistance system 9 will be described that can accurately narrow a communication destination with which a device which is a failure occurrence source tries to communicate, even if there is a plurality of communication destinations.

### Embodiment

### Configuration of Failure Assistance System

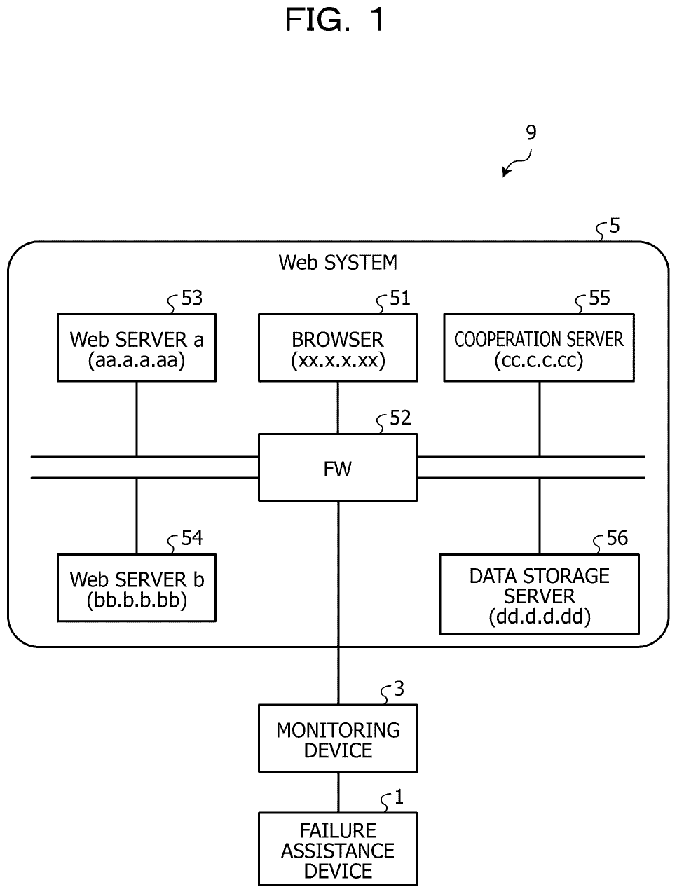

FIG. 1 is a diagram illustrating an example of a configuration of a failure assistance system according to the embodiment. As illustrated in FIG. 1, a failure assistance system 9 includes a Web system 5, a failure assistance device 1, and a monitoring device 3.

The Web system 5 applies a system same as the Web system 5A indicated in the reference example. For example, the Web system 5 is a system on which failure assistance is performed by the failure assistance system 9. The Web system 5 includes a browser 51, a FW 52, a Web server a (53), a Web server b (54), a cooperation server 55, and a data storage server 56. A number in parentheses is an IP address. Note that the browser 51 is an example of the first device. The Web server a (53) and the Web server b (54) are examples of the second device. The cooperation server 55 and the data storage server 56 are examples of the third device.

The browser 51 controls the third device (for example, cooperation server 55 or data storage server 56) via the second device (for example, Web server a (53) or Web server b (54)) using a communication message.

The FW 52 allows all the communication messages in the Web system 5A to pass therethrough. The FW 52 records a communication log, when the communication message passes therethrough. Each communication log is a log of first communication performed between the first device and the second device or a log of second communication performed between the second device and the third device. In each communication log, for example, a time when communication occurs, an IP address of a transmission source, an IP address of a destination, and the like are included.

The Web server a (53) and the Web server b (54) receive the communication message from the browser 51, generate a new communication message based on the received communication message, and transmit the generated communication message to a server of a communication destination. When receiving the communication message, the Web server a (53) and the Web server b (54) record an application log. In the application log, a time when communication occurs, an HTTP method, a URI, a response code, and the like are included. However, in the application log, a communication destination to which a new communication message is transmitted is not recorded. Therefore, although each of the Web server a (53) and the Web server b (54) communicates with the plurality of servers, which server is set as a transmission destination cannot be determined from the application log.

The cooperation server 55 and the data storage server 56 are servers controlled by the browser 51. Note that, although the servers controlled by the browser 51 are set as the cooperation server 55 and the data storage server 56, the cooperation server 55 and the data storage server 56 are merely examples, and the servers are not limited to these functions and names.

The monitoring device 3 monitors whether or not the Web system 5 is normally operating. Therefore, the monitoring device 3 collects and accumulates the communication logs of the FW 52, for example, periodically. In addition, the monitoring device 3 collects and accumulates the application logs of the Web server a (53) and the Web server b (54), for example, periodically. Furthermore, when detecting that a failure occurs, the monitoring device 3 transmits a communication log and an application log at the time of the failure occurrence to the failure assistance device 1.

The failure assistance device 1 performs failure assistance of the Web system 5. Note that details of the failure assistance device 1 will be described later.

### Functional Configuration of Failure Assistance Device

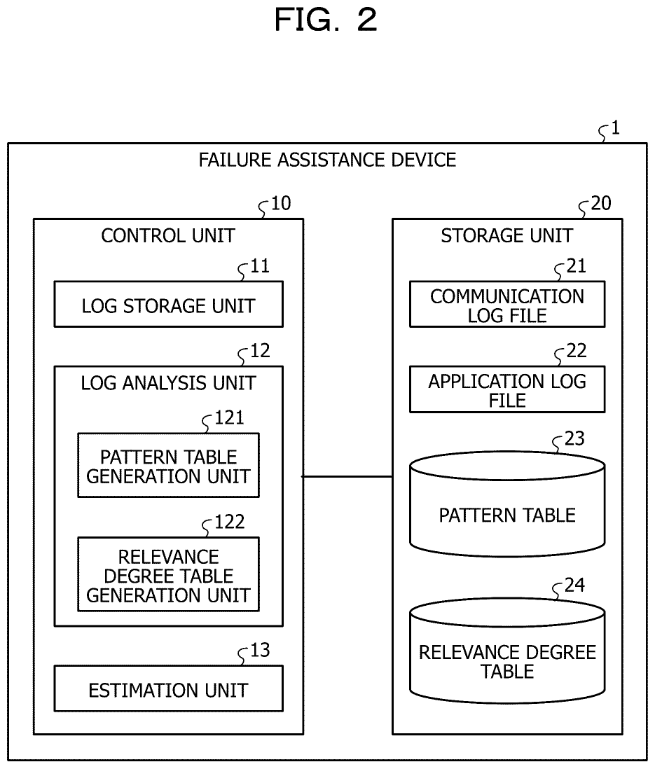

FIG. 2 is a diagram illustrating an example of a functional configuration of the failure assistance device according to the embodiment. As illustrated in FIG. 2, the failure assistance device 1 includes a control unit 10 and a storage unit 20.

The control unit 10 includes a log storage unit 11, a log analysis unit 12, and an estimation unit 13. The storage unit 20 includes a communication log file 21, an application log file 22, a pattern table 23, and a relevance degree table 24. Note that the application log file 22 is an example of first information. The communication log file 21 is an example of second information.

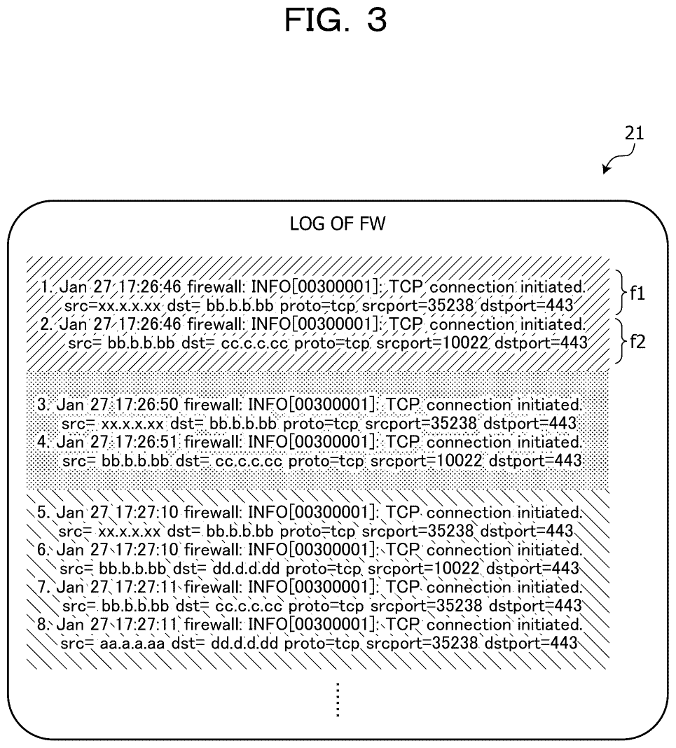

The communication log file 21 is a file that stores communication logs in a certain period, among the communication logs accumulated in the monitoring device 3. Here, an example of the communication log file 21 will be described with reference to FIG. 3.

FIG. 3 is a diagram illustrating an example of the communication log file according to the embodiment. As illustrated in FIG. 3, in each communication log, for example, a time when communication occurs, an IP address of a transmission source, an IP address of a destination, and the like are included.

As an example, a communication log indicated by a reference f1 stores “Jan27:17:26:46” as a time, “xx.x.x.xx” as an IP address of a transmission source (browser 51), and “bb.b.b.bb” as an IP address of a destination (Web server b (54)). A communication log indicated by a reference f2 stores “Jan27:17:26:46” as a time, “bb.b.b.bb” as an IP address of a transmission source (Web server b (54)), and “cc.c.c.cc” as an IP address of a destination (cooperation server (55)).

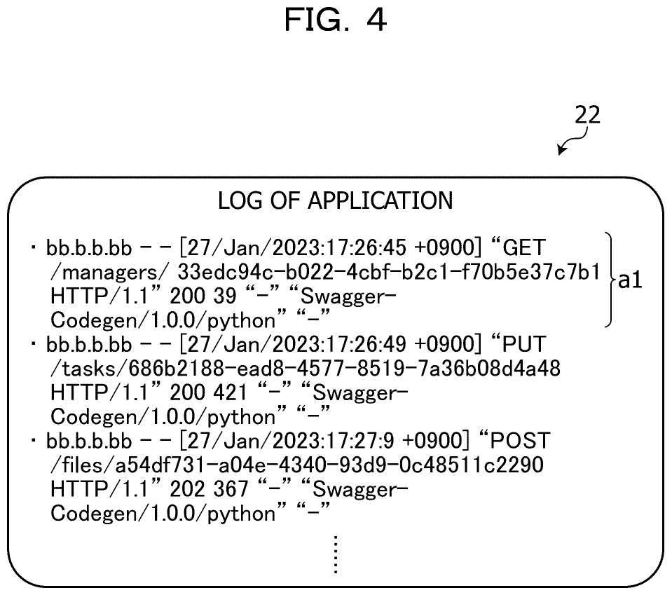

Returning to FIG. 2, the application log file 22 is a file that stores application logs in a certain period, among the application logs accumulated in the monitoring device 3. Here, an example of the application log file 22 will be described with reference to FIG. 4.

FIG. 4 is a diagram illustrating an example of the application log file according to the embodiment. As illustrated in FIG. 4, in each application log, for example, the time when the communication occurs, the HTTP method, the URI, the response code, and the like are included. The HTTP method indicates a type of a request from a browser to a Web server. As the HTTP method, for example, “GET”, “POST”, “PUT”, or the like is exemplified. The URI indicates an identifier used to identify a file to be accessed. The response code indicates a content of a response to the request.

As an example, an application log indicated by a reference a1 stores “27/Jan/2023:17:26:45+0900” as the time, “GET” as the HTTP method, “/managers/33 . . . c7b1” as the URI, and “200” as the response code.

Returning to FIG. 2, the pattern table 23 is information that stores a pattern of communication classified from the plurality of application logs included in the application log file 22. The pattern is classified by the HTTP method, the URI, and the response code included in the application log. Note that the pattern table 23 is generated by the log analysis unit 12 to be described later. An example of the pattern table will be described later.

The relevance degree table 24 is information that stores a relevance degree between server communications, for each pattern. The relevance degree table 24 is relevance degree information indicating a relevance degree between the first communication performed between the first device (browser 51) and the second device (Web server a (53) or Web server b (54)) and the second communication performed between the second device (Web server a (53) or Web server b (54)) and the third device (cooperation server 55 or data storage server 56). As the relevance degree, for example, the number of times of communications is exemplified. Note that an example of the relevance degree table 24 will be described later.

The log storage unit 11 stores the communication log and the application log in each file. For example, the log storage unit 11 acquires communication logs in a certain period from the monitoring device 3 and stores the communication logs in the communication log file 21. The log storage unit 11 acquires application logs in a certain period from the monitoring device 3 and stores the application logs in the application log file 22. Note that the log storage unit 11 executes the above processing before the failure assistance system 9 is operated.

The log analysis unit 12 analyzes the communication log and the application log. The log analysis unit 12 includes a pattern table generation unit 121 and a relevance degree table generation unit 122.

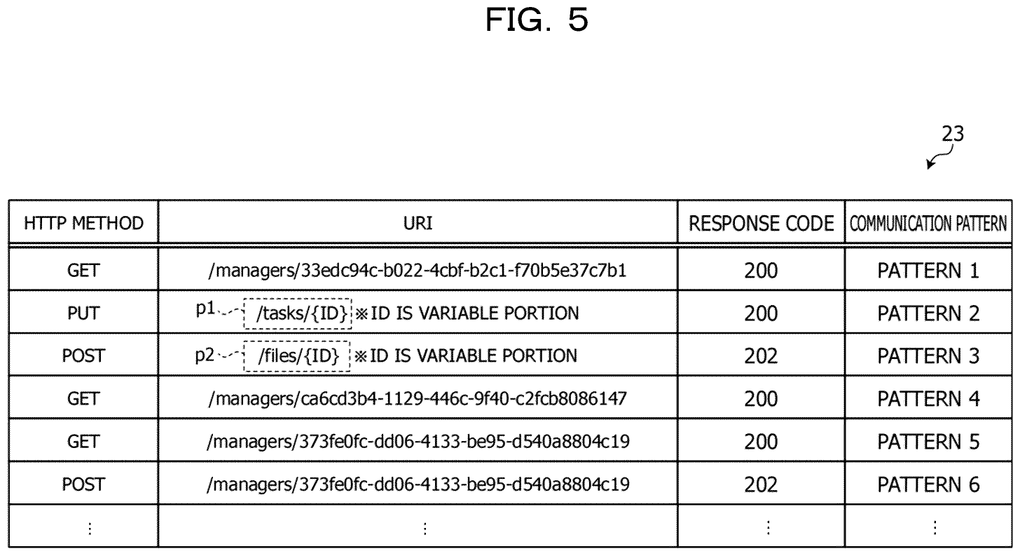

The pattern table generation unit 121 generates the pattern table 23 from the application log. For example, the pattern table generation unit 121 analyzes the plurality of application logs included in the application log file 22 and classifies a pattern used to identify communication. As an example, the pattern table generation unit 121 views all of the plurality of application logs included in the application log file 22, and in a case where the HTTP method, the URI, and the response code overlap, the pattern table generation unit 121 classifies the HTTP method, the URI, and the response code as a single pattern. Furthermore, the pattern table generation unit 121 views all of the plurality of application logs included in the application log file 22, and in a case where the HTTP method, the URI, and the response code do not overlap even once, the pattern table generation unit 121 determines that the variable portion is included in the URI and classifies a fixed portion of the URI, the HTTP method, and the response code as a single pattern. Then, the pattern table generation unit 121 stores the HTTP method, the URI, and the response code classified as the pattern and an identifier that uniquely identifies the pattern, in the pattern table 23. For example, the pattern table generation unit 121 allocates a communication pattern, for each request indicated by the HTTP method, the URI, and the response code. Here, an example of the pattern table 23 will be described with reference to FIG. 5.

FIG. 5 is a diagram illustrating an example of the pattern table according to the embodiment. As illustrated in FIG. 5, the pattern table 23 stores the HTTP method, the URI, the response code, and the communication pattern in association with each other. In the URI, as indicated by a reference p1, an ID after “/task/” is a variable portion. For example, in a case where the HTTP method is “PUT”, the URI is “/tasks/{ID}”, and the response code is “200”, a “pattern 2” is stored as the communication pattern. Furthermore, as indicated by a reference p2, an ID after “/files/” is a variable portion. For example, in a case where the HTTP method is “POST”, the URI is “/files/{ID}”, and the response code is “202”, a “pattern 3” is stored as the communication pattern.

Returning to FIG. 2, the relevance degree table generation unit 122 generates the relevance degree table 24 indicating the relevance degree between the first communication and the second communication, using the communication log stored in the communication log file 21, for each classified communication pattern. The first communication is the communication performed between the first device (browser 51) and the second device (Web server a (53) or Web server b (54)). The second communication is the communication performed between the second device (Web server a (53) or Web server b (54)) and the third device (cooperation server 55 or data storage server 56).

For example, the relevance degree table generation unit 122 refers to the pattern table 23 and classifies each application log included in the application log file 22 into the communication pattern. The relevance degree table generation unit 122 executes following processing on each application log. The relevance degree table generation unit 122 selects communication logs of the first communication and the second communication at a time for t seconds approximate to a time when the application log is generated, from the communication log file 21. The t seconds may be, for example, one second or two seconds, and it is sufficient that the t seconds be the number of seconds estimated to be communicated in association. As an example, it is sufficient that the relevance degree table generation unit 122 acquire a communication log for t seconds from the time when the application log is generated. As another example, it is sufficient that the relevance degree table generation unit 122 acquire a communication log for t seconds centered on the time when the application log is generated.

Then, the relevance degree table generation unit 122 counts the number of times of communications between the communications from the first communication to the second communication, as the relevance degree, from the selected communication log of the first communication and the selected communication log of the second communication, for the target application log. For example, the relevance degree table generation unit 122 adds one to the number of times of communications between the communications in the portion in the relevance degree table 24 corresponding to a communication pattern in which the target application log is classified.

When a failure occurs in the second device, the estimation unit 13 estimates the third device that is the communication destination to be controlled by the first device that is the communication source. For example, when detecting that a failure occurs in the Web server a (53) or the Web server b (54), the estimation unit 13 acquires a communication log and an application log when the failure occurs, from the monitoring device 3. The estimation unit 13 specifies a communication pattern corresponding to the application log when the failure occurs, from the pattern table 23. Then, the estimation unit 13 refers to the relevance degree table 24 corresponding to the specified communication pattern and acquires the relevance degree (the number of times of communications) between the communications with the first communication obtained from the communication log when the failure occurs. Then, the estimation unit 13 estimates a communication destination of the second communication of which the relevance degree between the communications (the number of times of communications) indicates the value equal to or more than the threshold, as a server of the communication destination to be controlled by the browser 51 that is the communication source. Note that it is sufficient to determine the threshold for each relevance degree table 24 corresponding to the communication pattern.

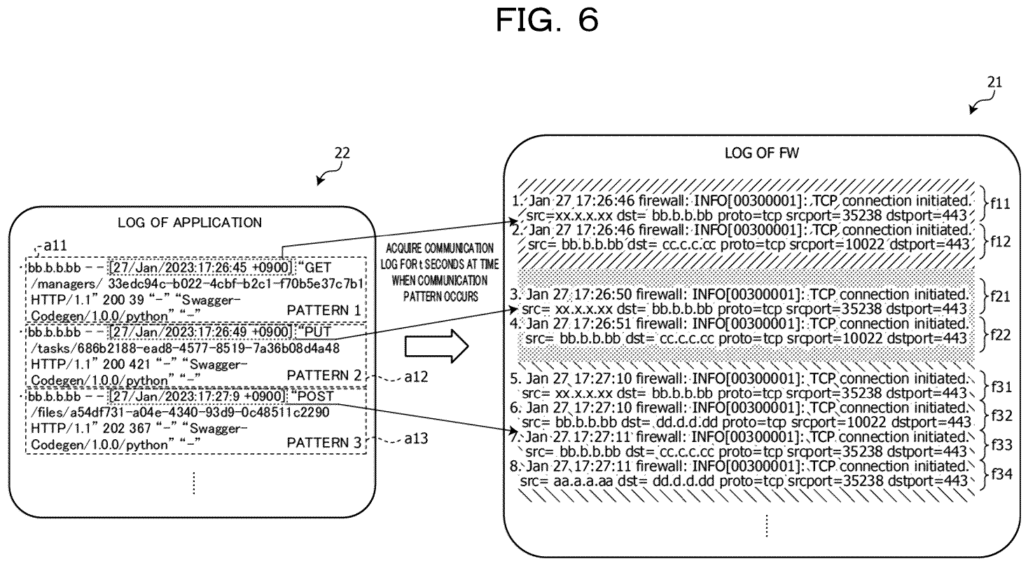

Here, processing for generating the relevance degree table 24 will be described with reference to FIG. 6. FIG. 6 is a diagram illustrating an example of relevance degree table generation processing according to the embodiment. As illustrated in FIG. 6, the application log file 22 is illustrated on the left, and the communication log file 21 is illustrated on the right.

Under such a situation, the relevance degree table generation unit 122 refers to the pattern table 23 and classifies each application log included in the application log file 22 into the communication pattern. Here, since the HTTP method is “GET”, the URI is “/managers/33edc94d . . . 1”, and the response code is “200”, an application log indicated by a reference a11 is classified into a pattern 1. Since the HTTP method is “PUT”, the URI is “/tasks/ . . . 1”, and the response code is “200”, an application log indicated by a reference a12 is classified into a pattern 2. Since the HTTP method is “POST”, the URI is “/files/ . . . 1”, and the response code is “202”, an application log indicated by a reference a13 is classified into a pattern 3.

Then, the relevance degree table generation unit 122 selects the communication logs of the first communication and the second communication at the time for t seconds approximate to the time when the application log is generated, from the communication log file 21, for each application log. Here, it is assumed that t seconds be two seconds. Then, for the application log indicated by the reference a11, the relevance degree table generation unit 122 selects a communication log for two seconds, for example, from the time when the application log is generated “27/Jan/2023:17:26:45+0900”. As an example, a communication log indicated by a reference f11 indicates the first communication from the browser 51 to the Web server b (54). A communication log indicated by a reference f12 indicates the second communication from the Web server b (54) to the cooperation server 55.

For the application log indicated by the reference a12, the relevance degree table generation unit 122 selects a communication log for two seconds, for example, from the time when the application log is generated “27/Jan/2023:17:26:49+0900”. As an example, a communication log indicated by a reference f21 indicates the first communication from the browser 51 to the Web server b (54). A communication log indicated by a reference f22 indicates the second communication from the Web server b (54) to the cooperation server 55.

For the application log indicated by the reference a13, the relevance degree table generation unit 122 selects a communication log for two seconds, for example, from the time when the application log is generated “27/Jan/2023:17:27:9+0900”. As an example, a communication log indicated by a reference f31 indicates the first communication from the browser 51 to the Web server b (54). A communication log indicated by a reference f32 indicates the second communication from the Web server b (54) to the data storage server 56. A communication log indicated by a reference f33 indicates the second communication from the Web server b (54) to the cooperation server 55. A communication log indicated by a reference f34 indicates the second communication from the Web server a (53) to the data storage server 56.

Then, the relevance degree table generation unit 122 counts the number of times of communications between the communications from the selected first communication to the selected second communication, as the relevance degree, for the target application log. For example, the relevance degree table generation unit 122 adds one to the number of times of communications between communications in the portion in the relevance degree table 24 corresponding to the communication pattern in which the target application log is classified.

Here, for the application log indicated by the reference a11, the relevance degree table generation unit 122 counts the number of times of communications between the communications from the first communication from the browser 51 to the Web server b (54) to the second communication from the Web server b (54) to the cooperation server 55, as the relevance degree. For example, the relevance degree table generation unit 122 adds one to the number of times of communications between the communications from the first communication from the browser 51 to the Web server b (54) to the second communication from the Web server b (54) to the cooperation server 55, in the relevance degree table 24 corresponding to the communication pattern “1” in which the application log indicated by the reference a11 is classified.

Furthermore, for the application log indicated by the reference a12, the relevance degree table generation unit 122 counts the number of times of communications between the communications from the first communication from the browser 51 to the Web server b (54) to the second communication from the Web server b (54) to the cooperation server 55, as the relevance degree. For example, the relevance degree table generation unit 122 adds one to the number of times of communications between the communications from the first communication from the browser 51 to the Web server b (54) to the second communication from the Web server b (54) to the cooperation server 55, in the relevance degree table 24 corresponding to the communication pattern “2” in which the application log indicated by the reference a12 is classified.

Furthermore, for the application log indicated by the reference a13, the relevance degree table generation unit 122 counts the number of times of communications between the communications from the first communication from the browser 51 to the Web server b (54) to the second communication from the Web server b (54) to the data storage server 56, as the relevance degree. In addition, the relevance degree table generation unit 122 counts the number of times of communications between the communications from the first communication from the browser 51 to the Web server b (54) to the second communication from the Web server b (54) to the cooperation server 55, as the relevance degree.

Then, the relevance degree table generation unit 122 adds one to the number of times of communications between the communications from the first communication from the browser 51 to the Web server b (54) to the second communication from the Web server b (54) to the data storage server 56, in the relevance degree table 24 corresponding to the communication pattern “3” in which the application log indicated by the reference a13 is classified. In addition, the relevance degree table generation unit 122 adds one to the number of times of communications between the communications from the first communication from the browser 51 to the Web server b (54) to the second communication from the Web server b (54) to the cooperation server 55.

### Example of Relevance Degree Table

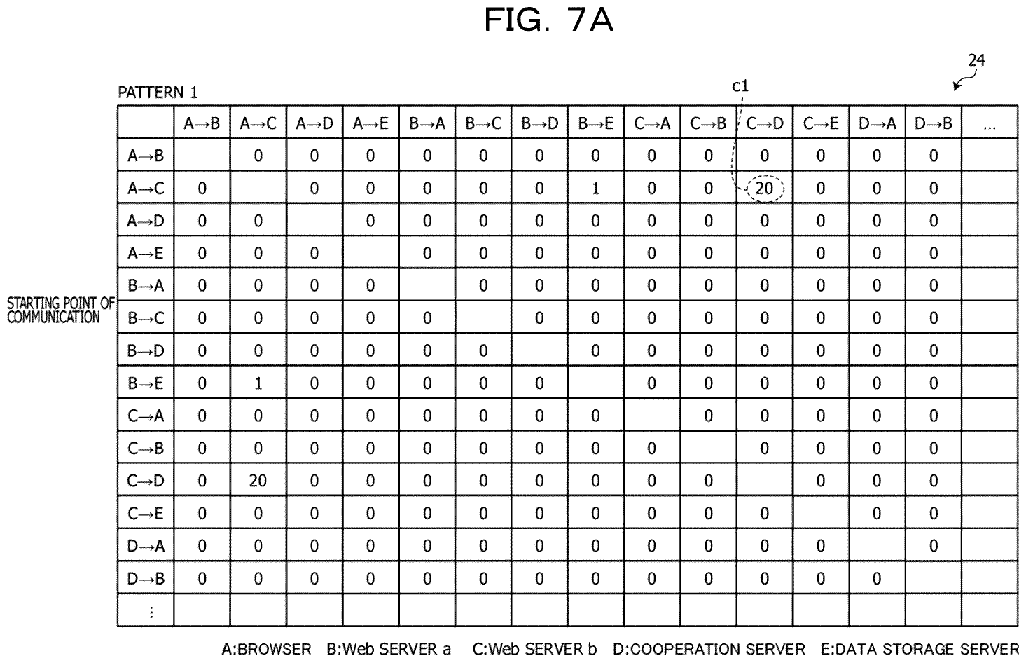

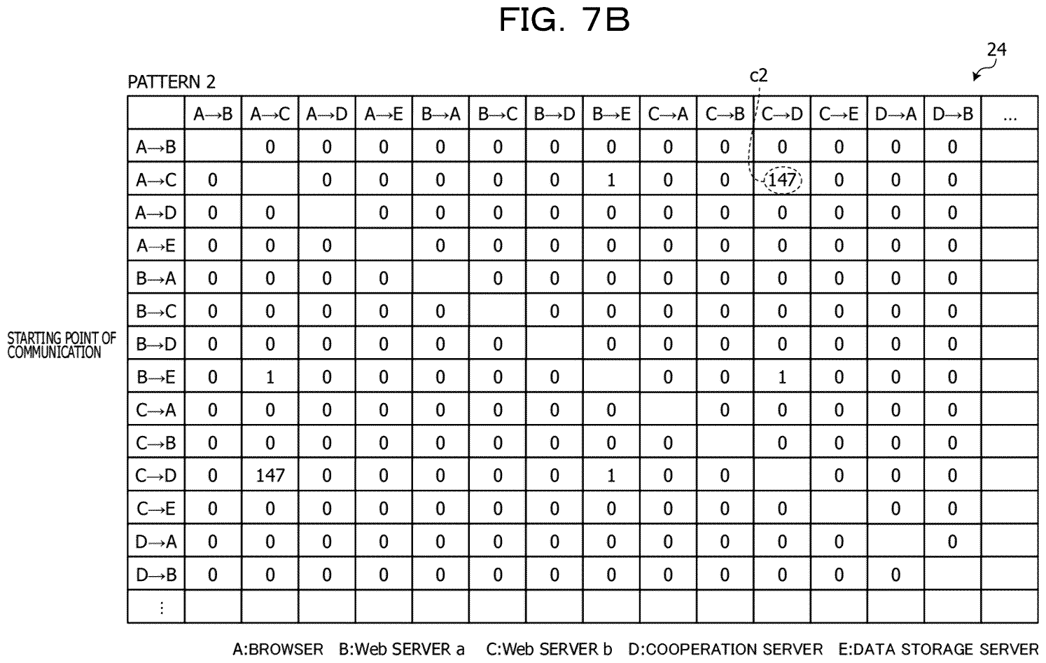

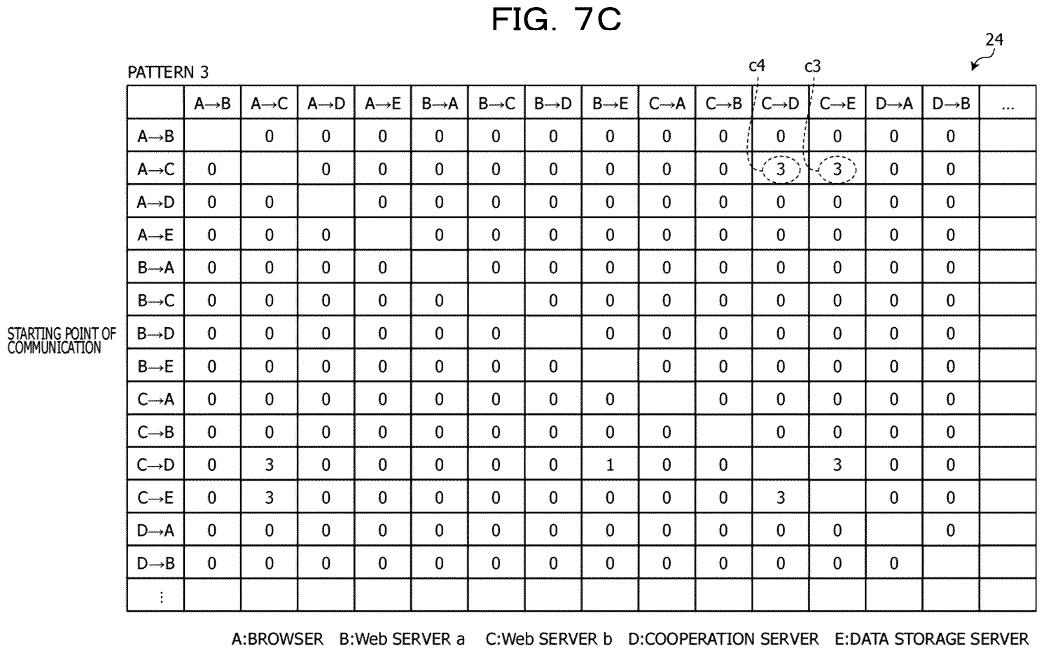

FIGS. 7A to 7C are diagrams illustrating an example of the relevance degree table according to the embodiment. Note that A to E described in the vertical axis and the horizontal axis of the relevance degree table illustrated in FIGS. 7A to 7C respectively correspond to the browser 51, the Web server a (53), the Web server b (54), the cooperation server 55, and the data storage server 56.

The relevance degree table 24 illustrated in FIG. 7A is a relevance degree table corresponding to the pattern 1. For the application log indicated by the reference a11 illustrated in FIG. 6, one is added to the number of times of communications between the communications from the communication of A→C to the communication of C→D. For example, a portion indicated by a reference C1 is “20”.

The relevance degree table 24 illustrated in FIG. 7B is a relevance degree table corresponding to the pattern 2. For the application log indicated by the reference a12 illustrated in FIG. 6, one is added to the number of times of communications between the communications from the communication of A→C to the communication of C→D. For example, a portion indicated by a reference c2 is “147”.

The relevance degree table 24 illustrated in FIG. 7C is a relevance degree table corresponding to the pattern 3. For the application log indicated by the reference a13 illustrated in FIG. 6, one is added to the number of times of communications between the communications from the communication of A→C to the communication of C→E. For example, a portion indicated by a reference c3 is “3”. In addition, one is added to the number of times of communications between the communications from the communication of A→C to the communication of C→D. For example, a portion indicated by a reference c4 is “3”.

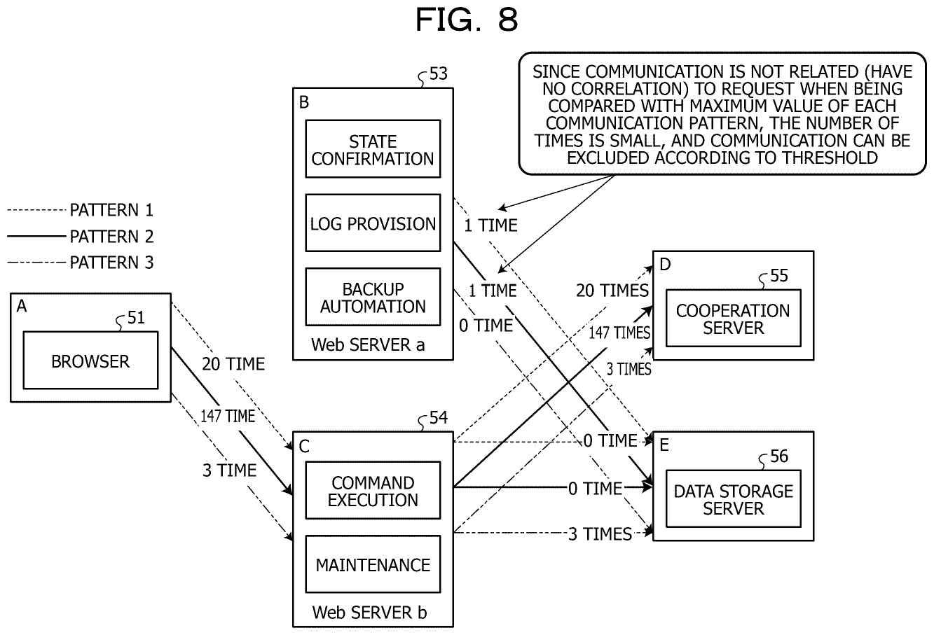

The relevance degree between the communications known from the relevance degree table 24 illustrated in FIGS. 7A to 7C will be described with reference to FIG. 8. FIG. 8 is a diagram illustrating the relevance degree between the communications. Note that, in FIG. 8, a relevance degree between communications in a case where A (browser 51)→C (Web server b (54)) is set as the starting point of the communication will be described.

As illustrated in FIG. 8, in the pattern 1, in a case where A (browser 51)→C (Web server b (54)) is set as the starting point of the communication, 20 times of communication of C (Web server b (54))→D (cooperation server 55) exist at a time close to the communication of A→C. Furthermore, once of communication of B (Web server a (53))→E (data storage server 56) exists, at the time close to the communication of A→C. This is because B (Web server a (53)) executes the backup automation function once at the close time, when C (Web server b (54)) executes the command execution function and the maintenance function. The communication of B (Web server a (53))→E (data storage server 56) is communication not related to the communication in a case where A→C is set as the starting point of the communication.

In the pattern 2, in a case where A (browser 51)→C (Web server b (54)) is set as the starting point of the communication, 147 times of communication of C (Web server b (54))→D (cooperation server 55) exist at a time close to the communication of A→C. Furthermore, once of communication of B (Web server a (53))→E (data storage server 56) exists, at the time close to the communication of A→C. This is because B (Web server a (53)) executes the backup automation function once at the close time, when C (Web server b (54)) executes the command execution function and the maintenance function. The communication of B (Web server a (53))→E (data storage server 56) is communication not related to the communication in a case where A→C is set as the starting point of the communication.

In the pattern 3, in a case where A (browser 51)→C (Web server b (54)) is set as the starting point of the communication, three times of communication of C (Web server b (54))→D (cooperation server 55) exist at a time close to the communication of A→C. In addition, three times of communication of C (Web server b (54))→E (data storage server 56) exist, at the time close to the communication of A→C.

The communication of B (Web server a (53))→E (data storage server 56) occurred in the patterns 1 and 2 is communication not related to the communication in a case where A→C is set as the starting point of the communication. Such communication can be excluded according to a threshold determined for each pattern.

### Example of Estimation Processing

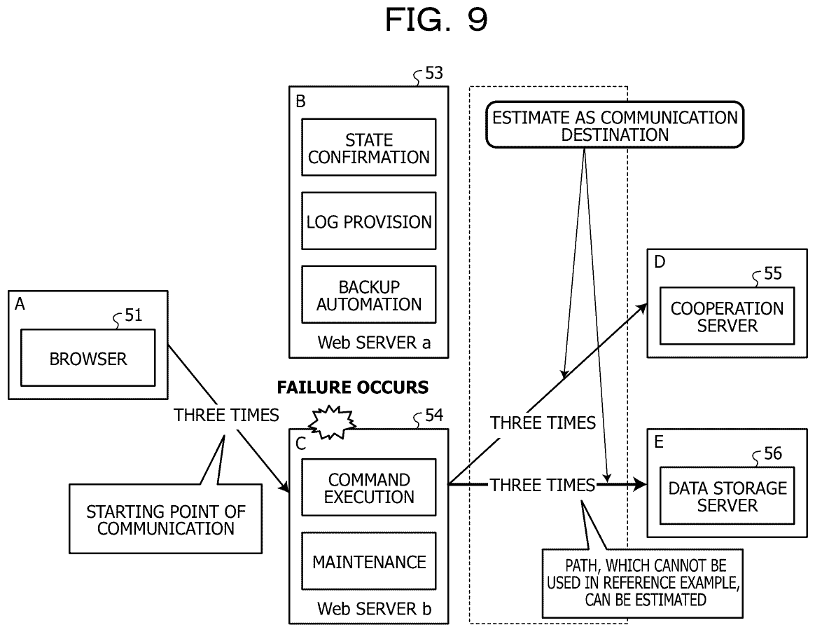

FIG. 9 is a diagram for explaining communication destination estimation at the time of failure occurrence. Note that, in FIG. 9, a case will be described where the relevance degree between the communications illustrated in FIG. 8 is used.

When detecting that a failure occurs in the Web server b (54), the estimation unit 13 acquires the communication log when the failure occurs and the application log of the Web server b (54), from the monitoring device 3. Here, it is assumed that the application log include a time when the communication occurs, “POST” as the HTTP method, “/files/ . . . ” as the URI, and “202” as the response code. It is assumed that the communication log include a time when the communication occurs, A (browser 51) as the IP address of the transmission source, and C (Web server b (54)) as the IP address of the destination. For example, the communication log is a case where the communication of A→C is set as the first communication.

Then, the estimation unit 13 specifies a communication pattern corresponding to the application log when the failure occurs, from the pattern table 23. Here, the pattern 3 is specified.

Then, the estimation unit 13 refers to the relevance degree table 24 corresponding to the specified communication pattern and acquires the relevance degree (the number of times of communications) between the communications with the first communication obtained from the communication log when the failure occurs. As an example, the estimation unit 13 refers to the relevance degree table 24 corresponding to the pattern 3 illustrated in FIG. 7C and acquires the second communication in a case where the starting point of the communication is set to A→C. Here, C (Web server b (54))→D (cooperation server 55) of which the number of times of communications as the relevance degree indicates “3” and C (Web server b (54))→E (data storage server 56) of which the number of times of communications as the relevance degree indicates “3” are acquired.

Then, the estimation unit 13 estimates a communication destination between the communications of which the number of times of communications indicates a value equal to or more than the threshold, as the server of the communication destination to be controlled by the browser 51 that is the communication source. It is assumed that a threshold corresponding to the pattern 3 be “1” as an example. Then, the number of times of communications between the communications of each of C (Web server b (54))→D (cooperation server 55) and C (Web server b (54))→E (data storage server 56) is equal to or more than the threshold and the relevance degree is high, D and E are estimated as the server of the communication destination. For example, the estimation unit 13 estimates D (cooperation server 55) and E (data storage server 56) as the servers of the communication destination to be controlled by the browser 51 that is the communication source.

In the reference example illustrated in FIG. 19, the communication of C→E has been excluded as the communication with a less communication frequency. On the other hand, the failure assistance device 1 according to the embodiment is not excluded as the communication with the less communication frequency, among the communication of the pattern 3. For example, even in a case where there is the plurality of communication destinations, the failure assistance device 1 can accurately narrow the communication destination with which a device (A) that is a failure occurrence source tries to communicate, by using the relevance degree table 24 for each communication pattern. For example, even if the number of times of communications is small, the failure assistance device 1 can narrow the communication as meaningful communication without overlooking the communication.

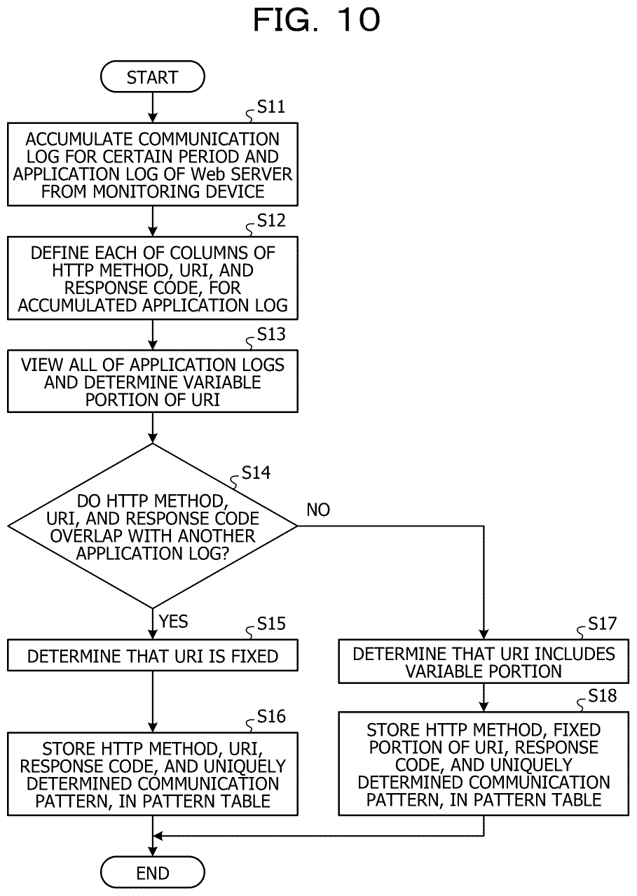

Here, a flowchart of failure assistance processing executed by the failure assistance device 1 according to the embodiment will be described with reference to FIGS. 10 to 12.

### Flowchart of Pattern Table Generation Processing

FIG. 10 is a diagram illustrating an example of a flowchart of pattern table generation processing according to the embodiment. As illustrated in FIG. 10, the failure assistance device 1 accumulates a communication log for a certain period and an application log of the Web server from the monitoring device 3 (step S11). For example, the failure assistance device 1 acquires the communication log for a certain period from the monitoring device 3 and stores the communication log in the communication log file 21. The failure assistance device 1 acquires the application log for a certain period from the monitoring device 3 and stores the application log in the application log file 22.

The failure assistance device 1 defines each of columns of the HTTP method, the URI, and the response code, for the accumulated application log (step S12).

Then, the failure assistance device 1 views all of the application logs of the Web server and determines a variable portion of the URI (step S13). For example, the failure assistance device 1 views all of the application logs of the Web server and selects an application log of which the HTTP method, the URI, and the response code do not overlap even once. Then, the failure assistance device 1 views all of the URIs of the selected application log and determines an overlapping fixed portion and a non-overlapping variable portion.

Then, the failure assistance device 1 determines whether or not the HTTP method, the URI, and the response code overlap, for each application log of the Web server (step S14). In a case where it is determined that overlap occurs (step S14; Yes), the failure assistance device 1 determines that the URI is fixed (step S15).

Then, the failure assistance device 1 stores the HTTP method, the URI, the response code, and a uniquely determined communication pattern of the application log of which the URI is determined to be fixed, in the pattern table 23 (step S16). Note that, in a case where the same HTTP method, URI, and response code already exist in the pattern table 23, the failure assistance device 1 does not store the HTTP method, the URI, and the response code. Then, the failure assistance device 1 ends the pattern table generation processing.

On the other hand, in a case where it is determined that overlap does not occur (step S14; No), the failure assistance device 1 determines that the URI includes the variable portion (step S17).

Then, the failure assistance device 1 stores the HTTP method, a fixed portion excluding the variable portion of the URI, the response code, and the uniquely determined communication pattern of the application log of which the URI is determined to include the variable portion, in the pattern table 23 (step S18). Note that, in a case where the same HTTP method, fixed portion of the URI, and response code already exist in the pattern table 23, the failure assistance device 1 does not store the HTTP method, the URI, and the response code. Then, the failure assistance device 1 ends the pattern table generation processing.

### Flowchart of Relevance Degree Table Generation Processing

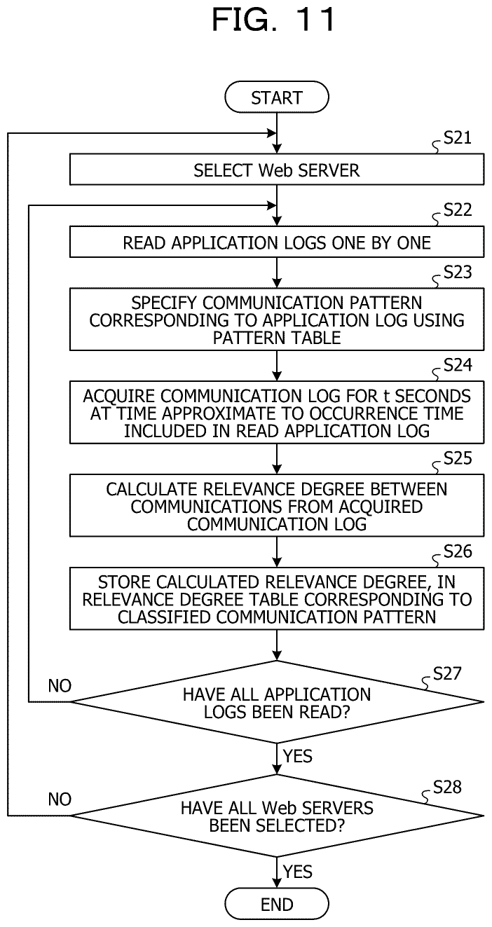

FIG. 11 is a diagram illustrating an example of a flowchart of relevance degree table generation processing according to the embodiment. As illustrated in FIG. 11, the failure assistance device 1 selects the Web server (step S21). The failure assistance device 1 reads application logs one by one (step S22). For example, the failure assistance device 1 reads the application logs one by one from the application log file 22.

The failure assistance device 1 specifies a communication pattern corresponding to the read application log, using the pattern table 23 (step S23). For example, the failure assistance device 1 specifies a communication pattern that matches an HTTP method, a URI, and a response code included in the read application log, using the pattern table 23.

Then, the failure assistance device 1 acquires a communication log for t seconds at a time approximate to an occurrence time included in the read application log (step S24). Then, the failure assistance device 1 calculates a relevance degree between communications from the acquired communication log (step S25). For example, the failure assistance device 1 specifies communication logs of the first communication and the second communication, from the acquired communication log. Then, the failure assistance device 1 adds one to the number of times of communications between the communications from the first communication to the second communication, as the relevance degree.

Then, the failure assistance device 1 stores the calculated relevance degree in the relevance degree table 24 corresponding to the classified communication pattern (step S26). For example, the failure assistance device 1 updates the number of times of communications at a portion where the first communication and the second communication intersect, in the relevance degree table 24 corresponding to the classified communication pattern, to the calculated number of times of communications.

Then, the failure assistance device 1 determines whether or not all the application logs have been read (step S27). In a case of determining that all the application logs have not been read (step S27; No), the failure assistance device 1 proceeds to step S22 so as to read a next application log.

On the other hand, in a case of determining that all the application logs have been read (step S27; Yes), the failure assistance device 1 determines whether or not all the Web servers have been selected (step S28). In a case of determining that all the Web servers have not been selected (step S28; No), the failure assistance device 1 proceeds to step S21 so as to select a next Web server.

On the other hand, in a case of determining that all the Web servers have been selected (step S28; Yes), the failure assistance device 1 ends the relevance degree table generation processing.

### Flowchart of Estimation Processing

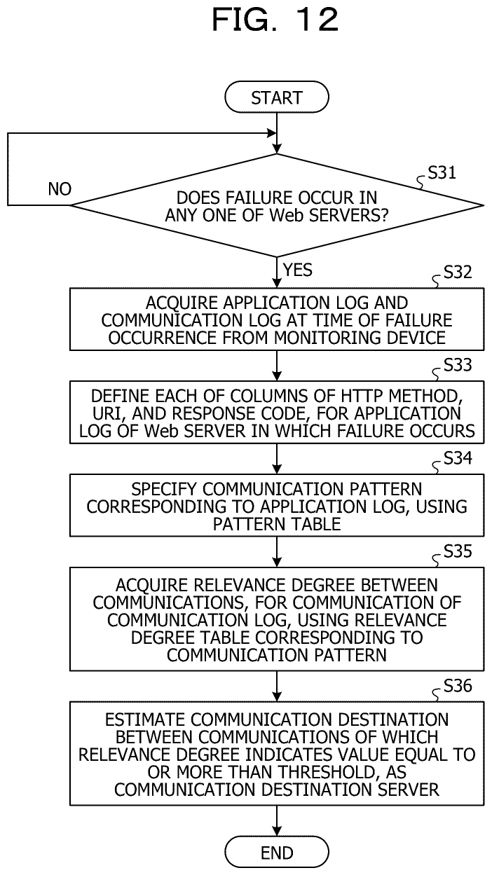

FIG. 12 is a diagram illustrating an example of a flowchart of estimation processing according to the embodiment. As illustrated in FIG. 12, the failure assistance device 1 determines whether or not a failure occurs in any one of the Web servers (step S31). In a case of determining that no failure occurs in all the Web servers (step S31: No), the failure assistance device 1 repeats the determination processing until a failure occurs in any one of the Web servers.

On the other hand, in a case of determining that a failure occurs in any one of the Web servers (step S31; Yes), the failure assistance device 1 acquires an application log and a communication log at the time of failure occurrence from the monitoring device 3 (step S32). Then, the failure assistance device 1 defines each of columns of the HTTP method, the URI, and the response code, for the application log of the Web server in which the failure occurs (step S33).

The failure assistance device 1 specifies a communication pattern corresponding to the application log at the time of failure occurrence, using the pattern table 23 (step S34). For example, the failure assistance device 1 specifies a communication pattern that matches the HTTP method, the URI, and the response code included in the application log at the time of failure occurrence, using the pattern table 23.

Then, the failure assistance device 1 acquire a relevance degree between the communications (the number of times of communications) for communication of the communication log at the time of failure occurrence, using the relevance degree table 24 corresponding to the specified communication pattern (step S35). For example, the failure assistance device 1 refers to the relevance degree table 24 corresponding to the specified communication pattern and acquires the relevance degree (the number of times of communications) between the communication with the first communication obtained from the communication log at the time of failure occurrence.

Then, the failure assistance device 1 estimates a communication destination between the communications of which the relevance degree (the number of times of communications) indicates a value equal to or more than the threshold, as the communication destination server (step S36). Then, the failure assistance device 1 ends the estimation processing.

### Effects of Embodiment

According to the above embodiment, the failure assistance device 1 performs failure assistance when a failure occurs in the Web system 5 in which the first device controls the third device via the second device using the communication message. The failure assistance device 1 classifies the communication pattern used to identify the communication, using the first information in which each of the plurality of communication messages transmitted from the first device to the second device is recorded. The failure assistance device 1 generates the relevance degree table 24 indicating the relevance degree between the first communication performed between the first device and the second device and the second communication performed between the second device and the third device, using the second information in which the communication logs between the first device, the second device, and the third device are recorded, for each classified communication pattern. When the failure occurs in the second device, the failure assistance device 1 specifies the communication pattern corresponding to the communication message when the failure occurs, from among the plurality of classified communication patterns. The failure assistance device 1 refers to the relevance degree table 24 corresponding to the specified communication pattern and estimates the third device that is the communication destination to be controlled by the first device that is the communication source. As a result, even in a case where there is the plurality of third devices that is the communication destination, the failure assistance device 1 can accurately narrow the third device that is the communication destination to be controlled by the first device that is the communication source and has transmitted the communication message to the second device in which the failure has occurred.

Furthermore, according to the above embodiment, the processing for generating the relevance degree information by the failure assistance device 1 selects the first communication and the second communication at the time approximate to the occurrence time of the communication message, from the second information, for each communication message included in the first information and generates the relevance degree table 24 that indicates the number of times of communications from the selected first communication to the selected second communication and corresponds to the communication pattern in which the communication message is classified. As a result, the failure assistance device 1 can generate the relevance degree table 24 corresponding to each communication pattern, by using the first information and the second information.

Furthermore, according to the above embodiment, the estimating processing by the failure assistance device 1 refers to the relevance degree table 24 corresponding to the specified communication pattern and estimates the third device of the second communication corresponding to the first communication obtained from the communication log when the failure occurs and corresponding to the first communication indicating the number of times of communications equal to or more than the threshold corresponding to the communication pattern, as the third device that is the communication destination to be controlled by the first device. As a result, the failure assistance device 1 can accurately narrow the communication destination with a high relevance degree with the communication when the failure occurs, by using the threshold corresponding to the communication pattern, regarding the relevance degree table 24 corresponding to the communication pattern.

Note that the illustrated failure assistance device 1 is described as a configuration separated from the monitoring device 3. However, the embodiment is not limited to this. The failure assistance device 1 may include the function of the monitoring device 3 and may have a configuration integrated with the monitoring device 3.

Furthermore, each of the illustrated components of the failure assistance device 1 is not necessarily physically configured as illustrated in the drawings. For example, specific aspects of separation and integration of the failure assistance device 1 are not limited to the illustrated ones, and all or a part of the device can be functionally or physically separated and integrated in an optional unit according to various loads, use states, or the like. Furthermore, the storage unit 20 may be coupled to an external device of the failure assistance device 1 via a network.

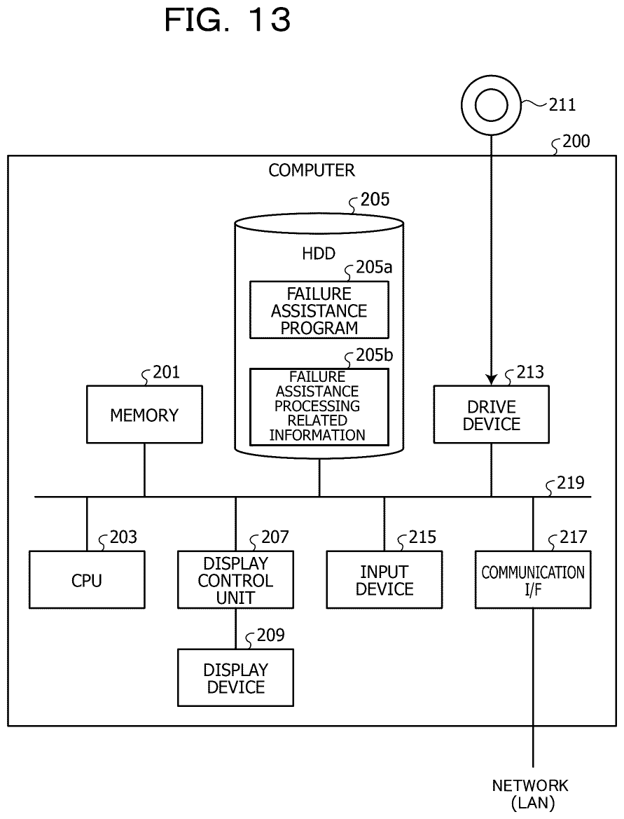

Furthermore, various types of processing described in the above embodiment can be achieved by a computer such as a personal computer or a work station executing programs prepared in advance. Thus, in the following, an example of a computer that executes a failure assistance program that achieves functions similar to the functions of the failure assistance device 1 illustrated in FIG. 2 will be described. Here, the failure assistance program that implements functions similar to the functions of the failure assistance device 1 will be described as an example. FIG. 13 is a diagram illustrating an example of a computer that executes the failure assistance program.

As illustrated in FIG. 13, a computer 200 includes a central processing unit (CPU) 203 that executes various types of arithmetic processing, an input device 215 that receives inputs of data from a user, and a display device 209. Furthermore, the computer 200 includes a drive device 213 that reads a program and the like from a storage medium, and a communication Interface (I/F) 217 that exchanges data with another computer via a network. Furthermore, the computer 200 includes a memory 201 that temporarily stores various types of information, and a hard disk drive (HDD) 205. Then, the memory 201, the CPU 203, the HDD 205, a display control unit 207, the display device 209, the drive device 213, the input device 215, and the communication I/F 217 are coupled by a bus 219.

The drive device 213 is, for example, a device for a removable disk 211. The HDD 205 stores a failure assistance program 205a and failure assistance processing related information 205b. The communication I/F 217 manages an interface between the network and the inside of the device, and controls input and output of data to and from another computer. As the communication I/F 217, for example, a modem, a local area network (LAN) adapter, or the like may be adopted.

The display device 209 is a display device that displays data such as a document, an image, or functional information, as well as a cursor, an icon, or a tool box. As the display device 209, for example, a liquid crystal display, an organic electroluminescence (EL) display, or the like may be adopted.

The CPU 203 reads the failure assistance program 205a, and loads the failure assistance program 205a into the memory 201 to execute the failure assistance program 205a as a process. Such a process corresponds to each functional unit of the failure assistance device 1. For example, information stored in the storage unit 20 is included in the failure assistance processing related information 205b. Then, for example, the removable disk 211 stores each piece of information such as the failure assistance program 205a.

Note that the failure assistance program 205a may not necessarily be stored in the HDD 205 from the beginning. For example, the program is stored in a “portable physical medium” such as a flexible disk (FD), a compact disc (CD)-read only memory (ROM), a digital versatile disc (DVD) disk, a magneto-optical disk, or an integrated circuit (IC) card inserted in the computer 200. Then, the computer 200 may read the failure assistance program 205a from these media to execute the failure assistance program 205a.

Furthermore, the processing executed by the failure assistance device 1 described in the above embodiment can be applied to failure assistance of a system that operates a service utilizing data.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a failure assistance program that performs failure assistance when a failure occurs in a control processing system in which a first device controls a third device via a second device by using a communication message, the failure assistance program for causing a computer to execute processing comprising:
classifying a communication pattern used to identify communication, by using first information in which each of a plurality of communication messages transmitted from the first device to the second device is recorded;
generating relevance degree information that indicates a relevance degree between first communication performed between the first device and the second device and second communication performed between the second device and the third device, by using second information in which a communication log between the first device, the second device, and the third device is recorded, for each classified communication pattern;
specifying a first communication pattern that corresponds to a communication message when a failure occurs, from among the plurality of classified communication patterns, when a failure occurs in the second device; and
estimating the third device that is a communication destination to be controlled by the first device that is a communication source, with reference to the relevance degree information that corresponds to the specified first communication pattern.

2. The non-transitory computer-readable recording medium according to claim 1, wherein
the processing of generating the relevance degree information selects the first communication and the second communication at a time approximate to an occurrence time of the communication message, from the second information, for each communication message included in the first information and generates the relevance degree information that indicates the number of times of communications from the selected first communication to the selected second communication and corresponds to a communication pattern in which the communication message is classified.

3. The non-transitory computer-readable recording medium according to claim 2, wherein
the processing of estimating refers to the relevance degree information that corresponds to the specified first communication pattern and estimates the third device of the second communication that corresponds to the first communication obtained from a communication log when a failure occurs and corresponds to the first communication that indicates the number of times of communications that corresponds to the first communication pattern and is equal to or more than a threshold, as the third device that is a communication destination to be controlled by the first device.

4. A failure assistance method that performs failure assistance when a failure occurs in a control processing system in which a first device controls a third device via a second device by using a communication message, the failure assistance method for causing a computer to execute processing comprising:
classifying a communication pattern used to identify communication, by using first information in which each of a plurality of communication messages transmitted from the first device to the second device is recorded;
generating relevance degree information that indicates a relevance degree between first communication performed between the first device and the second device and second communication performed between the second device and the third device, by using second information in which a communication log between the first device, the second device, and the third device is recorded, for each classified communication pattern;
specifying a first communication pattern that corresponds to a communication message when a failure occurs, from among the plurality of classified communication patterns, when a failure occurs in the second device; and
estimating the third device that is a communication destination to be controlled by the first device that is a communication source, with reference to the relevance degree information that corresponds to the specified first communication pattern.

5. A failure assistance system comprising:
a control processing system in which a first device controls a third device via a second device by using a communication message; and
a failure assistance device including a processor and configured to perform failure assistance when a failure occurs in the control processing system, wherein
the processor:
classifies a communication pattern used to classify communication, by using first information in which each of a plurality of communication messages transmitted from the first device to the second device is recorded;
generates relevance degree information that indicates a relevance degree between first communication performed between the first device and the second device and second communication performed between the second device and the third device, by using second information in which a communication log between the first device, the second device, and the third device is recorded, for each communication pattern;
specifies a first communication pattern that corresponds to a communication message when a failure occurs, from among the plurality of classified communication patterns, when a failure occurs in the second device; and
estimates the third device that is a communication destination to be controlled by the first device that is a communication source, with reference to the relevance degree information that corresponds to the first communication pattern.
